(19) United States
(12) Patent Application Publication
(10) Pub. No.: US 2007/0203930 A1
(43) Pub. Date: Aug. 30, 2007

(54) Method and System for Compression of Structured Textual Documents

(75) Inventors: Peter J. Spellman, Quincy, MA (US); Shabbir M. Dahod, Andover, MA (US); Michael Higgs, Waterloo, ON (CA); Sean Wellington, Newton, MA (US); Craig Leckband, Bedford, MA (US)

Correspondence Address: BOSTON IP LAW GROUP, TWO NEWTON PLACE, 255 WASHINGTON STREET, SUITE 200, NEWTON, MA, 02458, US

(73) Assignee: SUPPLYSCAPE CORPORATION, Woburn, MA (US)

(21) Appl. No.: 11/612,046

(22) Filed: Dec. 18, 2006

Related U.S. Application Data
(60) Provisional application No. 60/751,688, filed on Dec. 19, 2005.

(51) Int. Cl. G06F 7/00

(52) U.S. Cl. 707/101

(57) ABSTRACT

A method and system are provided for compressing structured documents. The method includes the steps of (a) receiving semantic information for a given class of documents; (b) receiving a document of the given class to be compressed; (c) decomposing the document into a plurality of strings; (d) identifying document specific strings from the plurality of strings based on the semantic information, and writing the document specific strings to output; (e) determining whether other strings of the plurality of strings of the document are referenced by a key in a shared database; (f) when a string of the other strings is referenced by a key in the shared database, writing the key to output in place of the string; and (g) when a string of the other strings is not referenced by a key in the shared database, adding the string to the shared database with an associated key, and writing the associated key to output in place of the string.

### RELATED APPLICATION

The present application is based on and claims priority from U.S. Provisional Patent Application No. 60/751,688 filed on Dec. 19, 2005 and entitled METHOD AND SYSTEM FOR COMPRESSION OF STRUCTURED TEXTUAL DOCUMENTS, which is incorporated herein by reference in its entirety.

### BACKGROUND OF THE INVENTION

1. Field of the Invention

The present application generally relates to a method and system for compressing structured textual documents, including, but not limited to, those encoded using the Extensible Markup Language (XML).

2. Related Art

A structured document is a document having organized content, e.g., a document that adheres to a particular template that organizes its content. Examples of structured documents include, but are not limited to, forms such as invoices, purchase orders, and certain kinds of financial reports.

Much of the current work in compressing structured documents is within the realm of XML. XML documents have the advantage of being self-describing, and often are human-readable. However, this flexibility considerably increases the amount of space needed to store an XML document. Several XML-specific compression implementations have addressed these issues by creating compact, binary representations of XML data. In these approaches, in a given XML document much of the markup that produces the document structure is repeated and can be more efficiently represented in a concise, non-XML format.

Another approach relies on an understanding of the document semantics to direct the compression more efficiently. In this method, semantically alike data elements are combined and compressed together, thus maximizing opportunities for the compressor to see related data. In either of these cases, the compression is “closed,” in that the analysis done for compressing a particular document is not reusable once the compression procedure has finished.

Moreover, compression methods that work with standard XML parsers must take great care to avoid information loss, especially when the encoded form of the document contains elements that are not part of the standard XML Infoset. This need is particularly acute when the document or a portion thereof is to be digitally signed and elements that XML parsers consider insignificant (e.g., line endings) are a critical component of the document.

### BRIEF SUMMARY OF EMBODIMENTS OF THE INVENTION

Various embodiments of the invention provide methods and systems for compressing structured documents. A method in accordance with one or more embodiments of the invention includes the steps of (a) receiving semantic information for a given class of documents; (b) receiving a document of the given class to be compressed; (c) decomposing the document into a plurality of strings; (d) identifying document specific strings from the plurality of strings based on the semantic information, and writing the document specific strings to output; (e) determining whether other strings of the plurality of strings of the document are referenced by a key in a shared database; (f) when a string of the other strings is referenced by a key in the shared database, writing the key to output in place of the string; and (g) when a string of the other strings is not referenced by a key in the shared database, adding the string to the shared database with an associated key, and writing the associated key to output in place of the string.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense, with the scope of the application being indicated by the claims.

### BRIEF DESCRIPTION OF THE DRAWINGS

FIG. 1 is a simplified block diagram illustrating an exemplary compression/decompression system in accordance with one or more embodiments of the invention.

FIG. 2 is a flow chart illustrating an exemplary process of compressing a document in accordance with one or more embodiments of the invention.

### DETAILED DESCRIPTION OF PREFERRED EMBODIMENTS

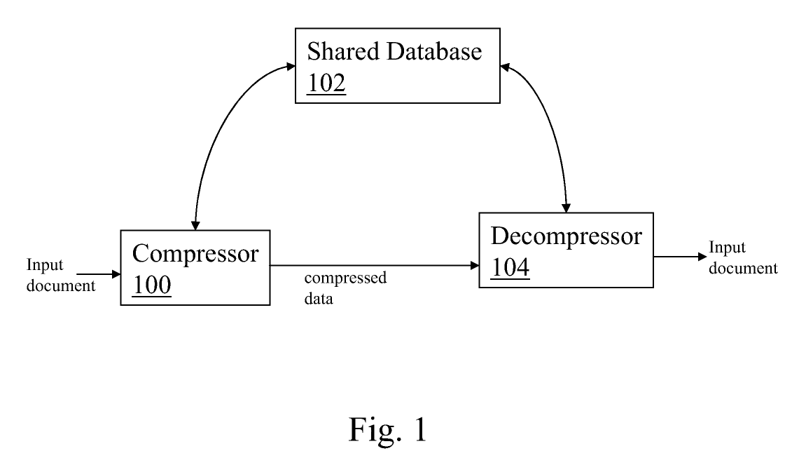

FIG. 1 is a simplified block diagram illustrating an exemplary compression/decompression system in accordance with one or more embodiments of the invention. Briefly, and as will be described in further detail below, the system includes a compression mechanism 100, which receives a structured document to be compressed. The compression mechanism 100 compresses textual data in the document by removing elements that are or may be common to multiple documents, and replacing those removed elements with keys, i.e., pointers to such elements in a common dictionary in a shared database 102. A decompression mechanism 104 receives data compressed by the compression mechanism 100, and reassembles the structured document by retrieving removed elements from the common dictionary 102.

The compression and decompression mechanisms are each preferably implemented in a general purpose computer. A representative computer is a personal computer or workstation platform that is, e.g., Intel Pentium®, PowerPC® or RISC based, and includes an operating system such as Windows®, Unix or the like. As is well known, such machines include a display interface (a graphical user interface or “GUI”) and associated input devices (e.g., a keyboard and mouse).

In accordance with various embodiments, the compression system is lossless, open, semantically-aware, and adaptive. The compression is lossless, in that all data passed into it is ultimately retained, regardless of whether or not the parser of the compressor considers it to be significant. The compression system is open, in that the text removed from the input data can be made available for the analysis of subsequent documents by adding it to a shared database. Text in the shared database is preferably stored once, irrespective of how many times it is referenced. It is semantically-aware, in that it utilizes externally supplied information about the data (in addition to the basic syntactic information supplied by the parser) to determine which portions are eligible for inclusion in the common dictionary of text strings. The compression system is also adaptive, in that it can handle input whose semantics are unknown or undefined by treating them as entries into the shared database by default.

Various embodiments of the invention include: a method for describing textual data that indicates which portions are to be considered document-specific, and which are likely to be seen across multiple documents; a method for communicating with a parser, which correlates extracted text strings with larger document structure; and a method for communicating with a database of shared text strings in order to assemble and disassemble compressed documents.

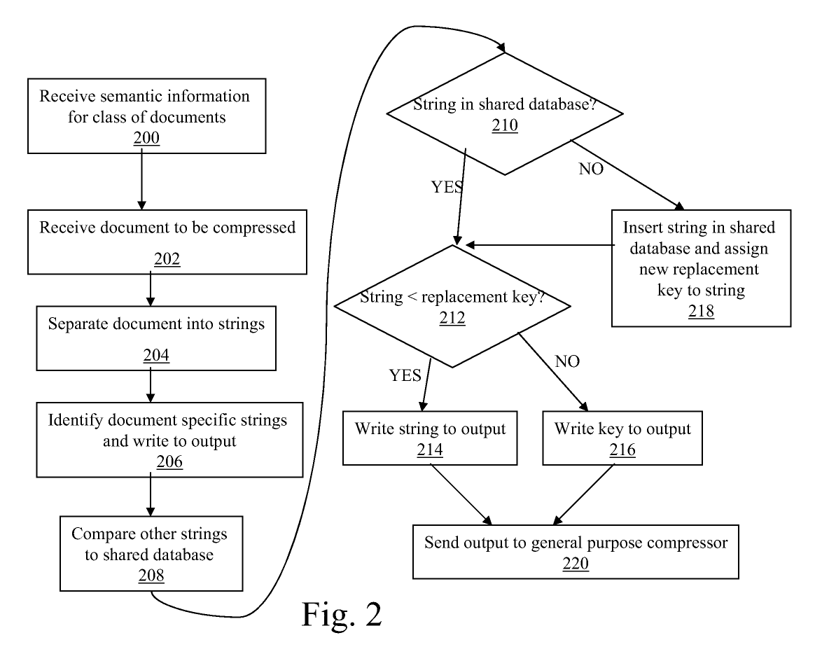

FIG. 2 is a flow chart illustrating an exemplary process of compressing a document in accordance with one or more embodiments of the invention. In this and other examples herein, the document to be compressed is an XML document. It should be understood, however, that XML is used only for purposes of illustration, and that documents of a wide variety of formats can be compressed in accordance with various embodiments of the invention. Examples of other standardized formats suitable for use in accordance with one or more embodiments of the invention include: SGML, ASN.1, ANSI ASC X12 EDI, YAML, and CSV.

At step 200, the compression mechanism receives semantic information for a given class of documents. At step 202, a document of the given class containing XML data is fed into a standard XML parser of the compression mechanism. This generates parser events that describe the structure of the document.

At the same time, at step 204, the input stream is buffered, and in conjunction with the supplied semantic information, is broken down in strings of text.

At step 206, using the supplied semantic information and basic syntactic information provided by the parser, strings of text deemed to be document specific are identified. These strings are retained and written to output.

At step 208, the other strings in the document are compared to entries in the common dictionary of the shared database. At step 210, a determination is made whether the string is in the shared database. If the string is in the shared database, then at step 212, a determination is made as to whether the string is smaller than the key that would replace it. If so, then at step 214, the string is written directly to output and no cross-reference against the shared database is made. If at step 212, the string is not determined to be smaller than the replacement key, the key is written to output at step 216.

If at step 210, the string is not found in the shared database, then at step 218, the string is inserted in the shared database, and a new key is assigned to replace the string. The process then continues to step 212.

Once the input has been exhausted, the output is a skeletal document comprising document-specific text strings and keys, i.e., pointers to text string stored in the shared database. This skeletal document is then fed into a general-purpose compressor at step 220 and is the final form of the document.

An example of how this is achieved is provided below. The following XML document is to be compressed:

<OrderId=”12345”>

<InvoiceNumber>RB235-2005</InvoiceNumber>
<OrderDate>2005-10-27</OrderDate>
<DeliveryAddress>

<Street>45 Main St.</Street>
<City>Waltham</City>
<State>MA</State>
<Zip>02453</Zip>

</DeliveryAddress>
<LineItem>

<Part>Shirt, Red</Part>
<Quantity>16</Quantity>

</LineItem>

</Order>

In documents of this type, the following elements are to be considered document-specific based on the semantic information provided for such documents and syntactic information provided by the parser: (a) the value of the Order tag's Id attribute, (b) the value of the InvoiceNumber element, (c) the value of the OrderDate element, and (d) the value of the Quantity element within a LineItem element.

The following XML Schema can be used, e.g., to describe this document and provide the supplied semantic information:

<xs:schema xmlns:xs=“http://www.w3.org/2001/XMLSchema”
elementFormDefault=“qualified” attributeFormDefault=“unqualified”>

<xs:element name=“Order” type=“orderType”/>
<xs:complexType name=“addressType”>

<xs:sequence>

<xs:element name=“Street” type=“xs:string”/>
<xs:element name=“City” type=“xs:string”/>
<xs:element name=“State” type=“xs:string”/>
<xs:element name=“Zip” type=“xs:string”/>

</xs:sequence>

</xs:complexType>
<xs:complexType name=“lineItemType”>

<xs:sequence>

<xs:element name=“Part” type=“xs:string”/>
<xs:element name=“Quantity” type=“xs:int”>

<xs:annotation>

<xs:appinfo>DS</xs:appinfo>

</xs:annotation>

</xs:element>

</xs:sequence>

</xs:complexType>
<xs:complexType name=“orderType”>

<xs:sequence>

<xs:element name=“InvoiceNumber” type=“xs:string”>

<xs:annotation>

<xs:appinfo>DS</xs:appinfo>

</xs:annotation>

</xs:element>
<xs:element name=“OrderDate” type=“xs:date”>

<xs:annotation>

<xs:appinfo>DS</xs:appinfo>

</xs:annotation>

</xs:element>
<xs:element name=“DeliveryAddress”
type=“addressType”/>
<xs:element name=“LineItem” type=“lineItemType”/>

</xs:sequence>
<xs:attribute name=“Id” type=“xs:ID” use=“required”>

<xs:annotation>

<xs:appinfo>DS</xs:appinfo>

</xs:annotation>

</xs:attribute>

</xs:complexType>

</xs:schema>

The annotation elements attached to the document-specific portions of the schema indicate this with the string “DS” contained in the appinfo element. The compression mechanism can consider unannotated strings to be shared by default.

In conjunction with the XML parser, this document is decomposed into the following text strings:

| Type | Value | Shared Database Key |
|---|---|---|
| Shared | <Order Id=“ | 1 |
| Document-specific | 12345 | |
| Shared | ”> | 2 |

<InvoiceNumber>

| | | |
|---|---|---|
| Document-specific | RB235-2005 | |
| Shared | </InvoiceNumber> | 3 |

<OrderDate>

| | | |
|---|---|---|
| Document-specific | 2005-10-27 | |
| Shared | </OrderDate> | 4 |

<DeliveryAddress>

<Street>45 Main

St.</Street>
<City>Waltham</City>
<State>MA</State>
<Zip>02453</Zip>

</DeliveryAddress>
<LineItem>

<Part>Shirt,

Red</Part>

<Quantity>

| | | |
|---|---|---|
| Document-specific | 16 | |
| Shared | </Quantity> | 5 |

</LineItem>

</Order>

Note that the text strings are not restricted or required to correlate exactly to XML tag start/end boundaries. They may span multiple tags and/or represent fragments of a single tag. Dictionary keys can be assigned sequentially. Document-specific text strings are not stored in the shared database, but rather are embedded directly in the compressed document. Thus, the compressed form of the document, using the symbols “S” to represent a reference to a shared text string, and “DS” to represent a document-specific one, can be said to be:
S 1
DS 12345
S 2
DS RB235-2005
S 3
DS 2005-10-27
S 4
DS 16
S 5

This would be the data fed into the general purpose compressor as indicated in step 220 above. If a second subsequent Order document were to arrive, any previously seen text strings stored in the shared database would be available during its compression. By way of example, consider the following second document:

<Order Id=”67890”>

<InvoiceNumber>FF23-2005</InvoiceNumber>
<OrderDate>2005-11-04</OrderDate>
<DeliveryAddress>

<Street>45 Main St.</Street>
<City>Waltham</City>
<State>MA</State>
<Zip>02453</Zip>

</DeliveryAddress>
<LineItem>

<Part>Shirt, Red</Part>
<Quantity>7</Quantity>

</LineItem>

</Order>

The second document could be decomposed into the following elements:

| Type | Value | Shared Database Key |
|---|---|---|
| Shared | <Order Id=“ | 1 |
| Document-specific | 67890 | |
| Shared | ”> | 2 |

<InvoiceNumber>

| | | |
|---|---|---|
| Document-specific | FF23-2005 | |
| Shared | </InvoiceNumber> | 3 |

<OrderDate>

| | | |
|---|---|---|
| Document-specific | 2005-11-04 | |
| Shared | </OrderDate> | 4 |

<DeliveryAddress>

<Street>45 Main

St.</Street>
<City>Waltham</City>
<State>MA</State>
<Zip>02453</Zip>

</DeliveryAddress>
<LineItem>

<Part>Shirt,

Red</Part>

<Quantity>

| | | |
|---|---|---|
| Document-specific | 7 | |
| Shared | </Quantity> | 5 |

</LineItem>

</Order>

The second document could have the following compressed representation:
S 1
DS 67890
S 2
DS FF23-2005
S 3
DS 2005-11-04
S 4
DS 7
S 5

Although there are now two different documents, they both reference the same entries in the shared database, thus reducing incremental storage cost for each additional document that makes use of the common text.

The shared database 102 may be simultaneously accessed by multiple applications, and such applications may even involve different business organizations. The shared database can be used in private and cooperative configurations. In a private configuration, a single business organization compresses documents using a shared database that is used solely by that business organization. Although multiple applications controlled by that business organization might make use of the shared database to compress documents, it ordinarily not made available outside the organization.

The cooperative configuration is an extension of the private configuration in that applications controlled by multiple distinct business organizations concurrently utilize a single shared database. In this configuration, each different business entity that accesses the shared database is able to leverage the entries added by each of the other user entities. Using the example above, if different businesses “A” and “B” were using the shared to compress their Order documents, and the first document was created by business A, and the second by business B, the entries created by A would be visible to and usable by B.

The cooperative configuration can be deployed in two different modes: on-line and replicated modes. In the on-line mode, there is a single instance of the shared database, and any addition made by one cooperating entity is immediately visible and usable by other cooperating entities. In the replicated mode, multiple copies of the shared database are distributed to each of the cooperating entities. Each copy of the replicated shared database functions independently of the others, and are periodically merged and redistributed to each of the participating partners.

The compression/decompression methods described herein are preferably implemented in software, and accordingly one of the preferred implementations of the invention is as a set of instructions (program code) in a code module resident in the random access memory of a computer. Until required by the computer, the set of instructions may be stored in another computer memory, e.g., in a hard disk drive, or in a removable memory such as an optical disk (for eventual use in a CD ROM) or floppy disk (for eventual use in a floppy disk drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the specified method steps.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

1. A method for compressing structured documents, comprising:
(a) receiving semantic information for a given class of documents;
(b) receiving a document of said given class to be compressed;
(c) decomposing the document into a plurality of strings;
(d) identifying document specific strings from said plurality of strings based on said semantic information, and writing said document specific strings to output;
(e) determining whether other strings of said plurality of strings of said document are referenced by a key in a shared database;
(f) when a string of said other strings is referenced by a key in said shared database, writing said key to output in place of said string; and
(g) when a string of said other strings is not referenced by a key in said shared database, adding said string to said shared database with an associated key, and writing said associated key to output in place of said string.

2. The method of claim 1 wherein step (f) further comprises determining whether said key is smaller than the string it references, and writing said key to output in place of said string only when said key is smaller than said string.

3. The method of claim 1 wherein step (g) further comprises determining whether said associated key is smaller than the string it references, and writing said associated key to output in place of said string only when said associated key is smaller than said string.

4. The method of claim 1 wherein said output comprises a skeletal document, and wherein the method further comprising compressing said skeletal document using a general data compressor.

5. The method of claim 1 wherein said semantic information comprises annotations in a schema for said given class of documents.

6. The method of claim 1 wherein said document has a format selected from a group consisting of XML, SGML, ASN.1, ANSI ASC X12 EDI, YAML, and CSV.

7. The method of claim 1 wherein a decompressor receives said output and reconstructs said document by communicating with said shared database to retrieve strings associated with the keys in said output.

8. The method of claim 1 further comprising repeating steps (b) to (g) for a plurality of documents of said given class.

9. A system, comprising:
a shared database for storing strings common to a plurality of structured documents and keys associated with said strings; and
a compressor for decomposing a received document to be compressed into a plurality of strings, identifying document specific strings from said plurality of strings based on semantic information received for a given class of documents, writing said document specific strings to output, determining whether other strings of said plurality of strings of said document are referenced by a key in said shared database, writing a key to output in place of a string of said other strings when the string is referenced by a key in said shared database, and when a string of said other strings is not referenced by a key in said shared database, adding said string to said shared database with an associated key, and writing said associated key to output in place of said string.

10. The system of claim 9 wherein said output comprises a skeletal document, and wherein said system further comprising a general data compressor for compressing said output.

11. The system of claim 9 further comprising a decompressor that receives said output and reconstructs said document by communicating with said shared database to retrieve strings associated with the keys in said output.

12. The system of claim 11 wherein said decompressor and said compressor are associated with the same business entity.

13. The system of claim 11 wherein said decompressor and said compressor are associated with different business entities.

14. The system of claim 9 wherein compressors and decompressors of a plurality of business entities access said shared database to compress and decompress documents.

15. The system of claim 9 wherein said compressor determines whether a key is smaller than the string it references, and writes said key to output in place of said string only when said key is smaller than said string.

16. The system of claim 9 wherein said semantic information comprises annotations in a schema for said given class of documents.

17. The system of claim 9 wherein said document has a format selected from a group consisting of XML, SGML, ASN.1, ANSI ASC X12 EDI, YAML, and CSV.

18. A computer program product residing on a computer readable medium having a plurality of instructions stored thereon which, when executed by the processor, cause that processor to:
(a) receive semantic information for a given class of documents;
(b) receive a document of said given class to be compressed;
(c) decompose the document into a plurality of strings;
(d) identify document specific strings from said plurality of strings based on said semantic information, and write said document specific strings to output;
(e) determine whether other strings of said plurality of strings of said document are referenced by a key in a shared database;
(f) when a string of said other strings is referenced by a key in said shared database, write said key to output in place of said string; and
(g) when a string of said other strings is not referenced by a key in said shared database, add said string to said shared database with an associated key, and write said associated key to output in place of said string.

19. The computer program product of claim 18 further including instructions for determining whether said key is smaller than the string it references, and writing said key to output in place of said string only when said key is smaller than said string.

20. The computer program product of claim 18 further including instructions for compressing said output.

21. The computer program product of claim 18 wherein said semantic information comprises annotations in a schema for said given class of documents.

22. The computer program product of claim 18 wherein said document has a format selected from a group consisting of XML, SGML, ASN.1, ANSI ASC X12 EDI, YAML, and CSV.

23. The computer program product of claim 18 further including instructions for repeating (b) to (g) for a plurality of documents of said given class.
